(19) United States
(12) Patent Application Publication
(10) Pub. No.: US 2003/0106594 A1
(43) Pub. Date: Jun. 12, 2003

(54) Normally open three-way valve for ultra-high-pressure application

(76) Inventors: Albert C. Saurwein, Granger, WA (US); Betty L. Boone-Saurwein, Granger, WA (US)

Correspondence Address: STRATTON BALLEW, 213 S 12TH AVE, YAKIMA, WA, 98902, US

(21) Appl. No.: 10/295,219

(22) Filed: Nov. 15, 2002

Related U.S. Application Data
(60) Provisional application No. 60/331,924, filed on Nov. 16, 2001.

(51) Int. Cl. F16K 11/044

(52) U.S. Cl. 137/625.5

(57) ABSTRACT

A normally open, two position, ultra-high-pressure three-way valve is comprised of a centrally internally situated short cylindrical spool conically profiled at each end, each end in close proximity to an orifice seat, each seat in fluid communication with an outlet port. Inlet flow through the body and into the interior chamber containing said short cylindrical profiled spool situated between fixed orifice seats can thus be directed through one open orifice seat and through its adjoining port to a downstream destination while the other seat is blocked; or upon shifting, through the other orifice seat and adjoining port to an alternate downstream destination while the first seat is blocked. The actuating stem, an integral part of the aforementioned short tapered cylindrical spool, extending concentrically through the orifice of the sealing seat on the stem end of the short cylindrical member, extends out through the body to external actuation means. Although designed as a three way, bypass valve for on-off control in uncompensated fluid circuits, in a second embodiment it can also be used as a true two position, three way valve.

### PRIORITY CLAIM

This application claims priority under U.S. Provisional Application No. 60/331,924 filed Nov. 16, 2001.

### FIELD OF THE INVENTION

This invention pertains primarily to high-pressure water-jet cutting devices for controlling the high pressure water flow to the cutting nozzle from a fixed displacement pump, but is also applicable to any high-pressure 2-position, 2-way valve application within allowable pressure-temperature limitations.

### BACKGROUND OF THE INVENTION

High-pressure flow to a water jet cutting nozzle, or any device to which high pressure fluid must be supplied (20,000 psi to 60,000 psi) is conventionally controlled by a high pressure on-off valve, actuated by an air or hydraulic cylinder or a toggle handle. Flow through the valve, otherwise called a two-way valve, is either blocked or open. This type of valve is compatible with flow out of an intensifier type pump, or any pressure compensated pump in which blocking the outlet flow does not result in over-pressurization of the fluid circuit. However, in the case of a non-compensated, fixed displacement pump where a blocked outlet would result in severe damage to the pump or pressure lines, a “three-way” valve is required to vent the pumped fluid from the nozzle back to the incoming water supply when the fluid to the nozzle is shut off. The valve of this invention also departs from the conventional design eliminating a return spring and integrated actuation cylinder structure using instead a purchased off-the-shelf spring return pneumatic cylinder. This significantly reduces the complexity and the resulting cost of manufacture.

### SUMMARY OF THE INVENTION

The valve of this invention provides on-off control in an ultra-high pressure fluid circuit in which the fluid medium is pressurized by a fixed volume non-compensated pump. This valve is relatively simple and inexpensive to build.

The stem of this normally open ultra-high pressure three-way valve actuates a short cylindrical spool within the valve body having a conical point at the end, and conically tapering at the other end down to the diameter of the actuating stem. This short cylindrical spool is made to reciprocate between two seats fixed within a main body, the stem being the actuating member passing coaxially through a rear seat and extending outside of the body to actuating means. An inlet port feeds the pressurized fluid to the annular cavity between the two seats, the fluid flowing through the seat at the pointed end of the cylindrical spool, through the adjoining port beyond the seat and to the nozzle or other load. In this position while the conical point is retracted from its seat allowing high pressure fluid to pass through, the taper at the other end seals against the seat at that end, and is held firmly in sealing contact with that seat by the pressure force on the profile of the cylindrical section within the body.

When the actuator shifts the stem forward, the conical point is pushed onto sealing contact with the forward seat blocking high pressure flow to the nozzle or other load while simultaneously opening the annular area between the rear seat and the stem allowing flow to pass through that annular area inside the rear seat and out through the second outlet or bypass part to a low pressure destination, typically back to the inlet fluid supply.

This open and close cycle shifting high pressure fluid from the load to low pressure vented fluid and back again can all be done with the pump running and results in very smooth operation.

The remote actuator is a separate off-the-shelf component and is bolted to the body through adapter blocks.

The high pressure port is on one long edge surface of the body providing fluid passage into the interior cavity between the two fixed seats. Both outlet ports are on the opposite edge surface. The end of the body beyond the seat at the stem end houses a high pressure plug. Removal of this plug gives access to the internal cavity through which the stem is inserted into the body followed by the seat-retainer assembly. A plug in the opposite end when removed gives access to the rear seat-retainer assembly and the stem guide.

In an embodiment, the valve body has two threaded holes spaced apart in from the edge where the high pressure plug is located by which to mount the assembly. One of the major advantages of this high pressure valve is that the actuating stem does not pass through a region of high pressure and a sliding high pressure seal is not necessary.

### BRIEF DESCRIPTION OF THE DRAWINGS

Five figures are included in this application:

FIG. 1 shows the orientation and attachment means of the mounting blocks to the main body, and actuation cylinder to the mounting blocks.

FIG. 2 is a section through the main body showing the valve porting, the stem configuration, and interior components.

FIGS. 3 and 4 are two times size illustrations of the flow route through the valve and accompanying stem position for bypass flow and pressurized flow to the nozzle respectively.

FIG. 5 is an illustration of a second embodiment of the invention.

### DETAILED DESCRIPTION OF THE INVENTION

The ultra-high pressure 3-way valve of this invention is designed with a standard high pressure inlet port 2 on one side of the body 1, and on the opposite side are outlet pressure port 4 and bypass port 5.

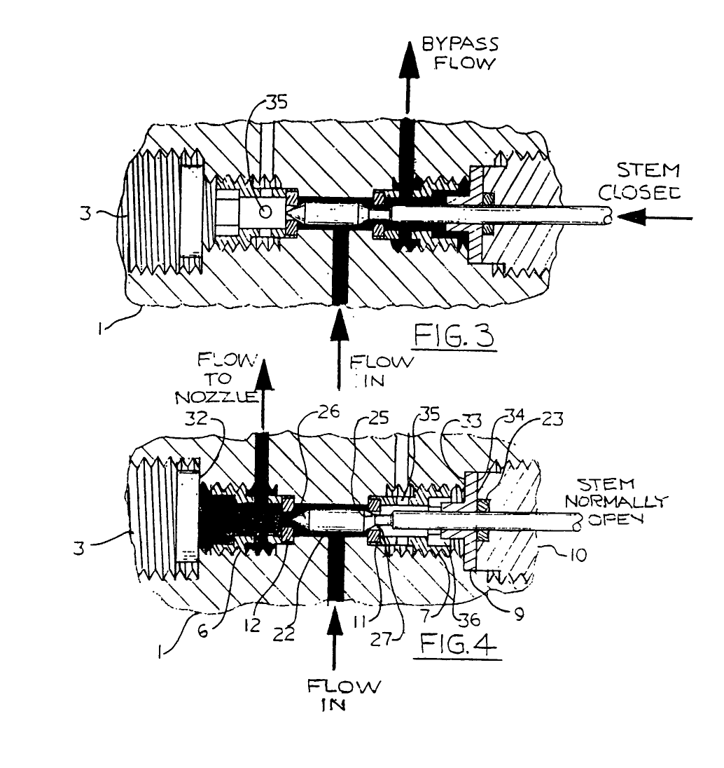

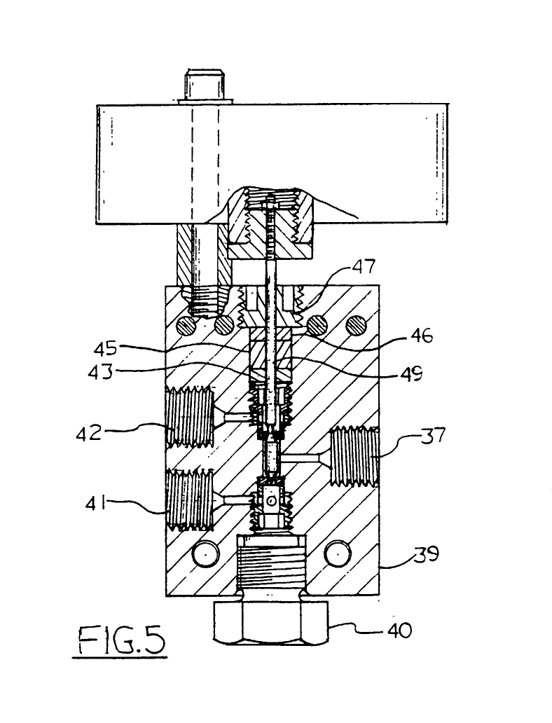

High pressure fluid enters the interior cavity 24, through inlet port 2, and in the normally open condition in which the actuator 20 has not been energized, and the stem 14, is in the rearward position as in FIG. 4 the taper 25 is in sealing contact with rear seat 11, held there by the force exerted on said stem by the piston return spring within said actuator. When pressure has built within said internal cavity, the sealing force between said tapered surface and seat increases to the amount of the pressure force on the effective area of the stem profile, thus increasing the sealing capability as pressure increases.

Shifting said stem away from said rear seat such that the tapered point 26 is forced into sealing contact with forward seat 12, and said rear tapered surface 25 withdraws from rear seat 11 redirects the inlet fluid flow from said outlet pressure port to bypass port 5, as shown in FIG. 3.

The short cylindrical spool 22 having sealing tapers on each end is concentrically situated within said internal pressurized cavity, bounded at each end with said tapered sealing surfaces and between said seats. The annular area developed between the inside orifice diameter in said rear orifice seat and the diameter of the concentrically situated stem within said orifice, said stem diameter being at the small end of said rear taper, produces a minimal pressure drop through said annular area at rated flow conditions when the stem is in the actuated or bypass position as shown on FIG. 3.

The stem diameter increases beyond the region of the said rear seat orifice to slightly less than that of said rear seat orifice inside diameter to allow assembly of said stem from the far side of said body at which time said seat 11 and threaded plug 7 are assembled and torqued into the body along with stem guide 9 and retainer plug 10 containing o-ring seal 23.

Said stem thus assembled extends beyond the perimeter of said body, its threaded end firmly torqued within adapter plug 15 and locked thereto by nut 13. Threaded engagement of said adapter plug with the internal thread 31 in the end of the actuator piston 16 provides the attachment required to transmit both the compressive force to shift said stem from the normally open position to closed, and to retract said stem and hold in the on position by spring return means within said actuating cylinder. Stand-off spacers 17, between mounting blocks 19 and said actuator cylinder hold said actuator in a position near mid stroke where the return spring is active while still allowing sufficient further stroke for valve actuation. Said stand-off spacers and cylinder are attached to said mounting blocks by bolts 18. Said mounting blocks are attached to said body by bolts 21.

Threaded plugs 6 and 7 retain their respective seats 12 and 11, in small counterbores in the inner ends, and when torqued into their respected threaded counterbores exert compressive force on their respective seats sandwiched against the counterbores outside each end of the interior cavity 24. Sufficient force is thus generated to produce a high pressure seal in the annular area of contact between rear seat 11 and its mating counterbore preventing high pressure leakage into the bypass port during high pressure flow through said internal cavity and downstream to the nozzle or other load. A similar high pressure sealing system is formed between threaded plug 6 and seat 12 with its mating counterbore, but this side of said internal cavity never experiences a pressure differential across the seat in this first embodiment. Holes 35 are provided in the walls of said threaded plugs through which the fluid passes to enter either of said outlet ports. Said threaded plugs are constructed from standard corrosion resistant socket-type set screws, the internal hexes 36, at the outer end of each providing the driving and torquing means for assembly and sealing preload of said orifice seats as previously described. The wall of the counterbore in the smaller end of the threaded plug which retains the orifice seat is slightly shorter than the thickness of the orifice seat insuring that the seat absorbs the full load applied through torquing the plug and that contact of the counterbore walls with the surface of the mating counterbore in the body does not occur.

Threaded plug 3 screws into said body seating against the polished counterbore seat 32 and upon torquing establishes a high pressure seal in the interface.

Low pressure water present on the stem side of said internal cavity is prevented from leaking past said stem by o-ring 23, and past threaded retainer plug 10 by the interface pressure generated on both side surfaces 33 and 34 of stem guide 9 by torquing said retainer plug. Holes 37 to accommodate a spanner wrench are provided in said retainer plug to facilitate torquing thereof. Two threaded mounting holes 8 are provided in the plug end of said body.

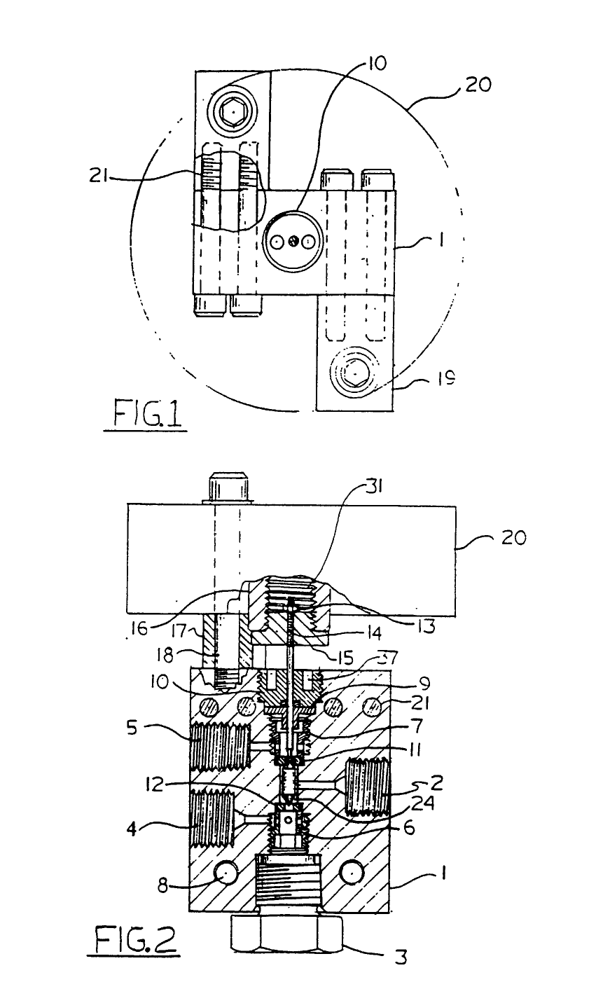

A second embodiment of the 3-way ultra-high-pressure valve of this invention would replace the bypass port 5, body 1, stem 14, stem guide 9, and retaining plug with o-ring seal 10 and 23, all of the first embodiment, with high pressure port 42, body 39, stem 49, stem guide 43, high pressure seal 45, and retaining plug 47. (FIG. 5). All other valve components are identical to the first configuration shown in FIGS. 1 through 4, as is the operational sequence illustrated in FIGS. 3 and 4. This second embodiment would direct high pressure flow coming into port 37 to either of two high pressure down stream loads through ports 41 or 42 by the same shifting-actuation and internal alternate sealing and opening sequence means as described in the previous specification and illustrated in FIGS. 3 and 4.

What is claimed is:

1. A normally open three-way valve for ultra high pressure application, substantially as shown and described herein.
